(19) United States
(12) Patent Application Publication
(10) Pub. No.: US 2024/0256717 A1
(43) Pub. Date: Aug. 1, 2024

(54) SECURE STORAGE AND TRANSPORT OF DOCUMENTS

(71) Applicant: Michele E. Fisher, Northglenn, CO (US)

(72) Inventor: Michele E. Fisher, Northglenn, CO (US)

(21) Appl. No.: 18/429,362

(22) Filed: Jan. 31, 2024

Related U.S. Application Data
(60) Provisional application No. 63/482,460, filed on Jan. 31, 2023.

(51) Int. Cl. G06F 21/78; G06F 21/32

(52) U.S. Cl. CPC G06F 21/78; G06F 21/32

(57) ABSTRACT

A method for secure storage and transport of documents includes capturing one or more physiological or behavioral characteristics with a biometric scanner provided to a USB credit card flash drive, comparing the captured one or more physiological or behavioral characteristics with one or more physiological or behavioral characteristic templates previously stored as part of a user account to the USB credit card flash drive and, based upon results of the comparing, controlling access to verifying documents previously stored to the USB credit card flash drive and accessible through the user account. A system for secure storage and transport of documents includes a USB credit card flash drive having a shell housing a storage component, a biometric scanner, a processor and an input/output all mutually operatively coupled. A computer program product configures the processor for secure storage and transport of documents.

### CROSS-REFERENCE TO RELATED APPLICATIONS

This application claims the priority benefit of U.S. Provisional Application No. 63/482,460 filed on 31 Jan. 2023, pending, which is incorporated herein by reference in its entirety.

### SUMMARY

The disclosure describes a method for secure storage and transport of documents. The method includes capturing one or more physiological or behavioral characteristics with a biometric scanner provided to a USB credit card flash drive, comparing the captured one or more physiological or behavioral characteristics with one or more physiological or behavioral characteristic templates previously stored as part of a user account to the USB credit card flash drive and, based upon results of the comparing, controlling access to verifying documents previously stored to the USB credit card flash drive and accessible through the user account.

The disclosure also describes a system for secure storage and transport of documents. The system includes a USB credit card flash drive having a shell housing a storage component, a biometric scanner, a processor and an input/output all mutually operatively coupled. The processor is configured to capture one or more physiological or behavioral characteristics with the biometric scanner, compare the captured one or more physiological or behavioral characteristics with one or more physiological or behavioral characteristic templates previously stored as part of a user account to the storage component and, based upon results of the comparison, control access to verifying documents previously stored to the storage component and accessible through the user account.

Further, the disclosure describes a computer program product having a non-transitory computer readable storage medium and program code embodied therewith. The program code is executable by a processor to capture one or more physiological or behavioral characteristics with a biometric scanner provided to a USB credit card flash drive, compare the captured one or more physiological or behavioral characteristics with one or more physiological or behavioral characteristic templates previously stored as part of a user account to the USB credit card flash drive and, based upon results of the comparison, control access to verifying documents previously stored to the USB credit card flash drive and accessible through the user account.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a flow of an example enrollment method for secure storage and transport of documents.

FIG. 2 illustrates a flow of an example method for secure storage and transport of documents.

FIG. 3 schematically illustrates an example system for secure storage and transport of documents.

FIG. 4 schematically illustrates of various functional components of an example system for secure storage and transport of documents.

FIG. 5 schematically illustrates the example system of FIG. 3 with an extended connector.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Refugees and others are often required to leave their residences with little or no warning and have no proof of who they are, rendering them and their families stuck in refugee camps for many years unable to access aid and possible re-location, that they are likely eligible for. Those in danger of fire or other environmental disasters that destroy homes/residences without enough warning are often unable to gather necessary documents.

Known solutions to storing verification or verifying documents such as medical records, certifications, asset ownership proof, licenses, insurances, and any other important documents include storage online, in a file or in a safety deposit box at the bank.

Embodiments of the present disclosure substantially eliminate, or at least partially address, problems in the prior art, enabling users to readily and easily access medical records, certifications, asset ownership proof, licenses, insurances, and any other important documents suitable for verifying or confirming permissions or conditions of the holder. Biometric security features protect against password hacking.

By virtue of a portable size that fits into the wallet that a person carries already and the ability to store and retrieve the critical information when needed embodiments of the present disclosure also substantially eliminate the need for critical documents to be stored somewhere that may become inaccessible or that the person may be distanced from.

Additional aspects, advantages, features and objects of the present disclosure will be made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

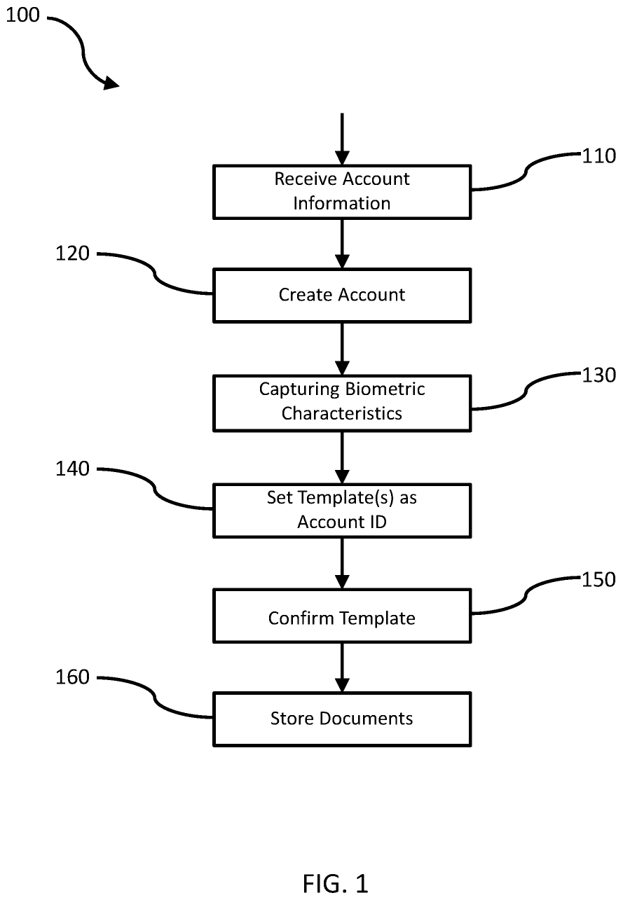

FIG. 1 illustrates actions of a computer-implemented method 100 for setting up secure storage and transport of documents in accordance with an embodiment of the present disclosure. The method is depicted as a collection of actions in a logical flow diagram, which represents a sequence of actions that may be implemented in hardware, software, or a combination thereof.

During an enrollment phase, the computer-implemented method includes receiving user profile information at 110 and creating a user profile or account on a storage component of a USB credit card flash drive at 120 which, in part, includes the profile information.

With one or more components of the USB credit card flash drive, one or more physiological, anatomical or behavioral characteristics of a user are captured at 130. As physiological, anatomical or behavioral characteristics of the user, one or more of fingerprints, palm vein images, DNA, palm print, hand geometry, ear shape, facial images, iris images, odor/scent and voices may be captured. Physiological, anatomical or behavioral characteristics may also include behaviometrics such as gestures, mouse movement, typing rhythm, gait, signature.

Information/data representative of one or more physiological or behavioral characteristics may be collected and sampled to create the one or more physiological or behavioral characteristic templates at 140. With the one or more physiological or behavioral characteristic templates, the profile and/or account are initialized on a USB credit card flash drive or other suitable mobile electronic device.

On the storage component, one or more of the physiological or behavioral characteristic templates are stored in reference to, in association with or in connection with the user profile. For example, in a record of the user profile or account, the one or more templates may be registered as the artifacts representing identity of the user and/or the user's authorization to access the user profile as well as features, facets and extensions thereof.

In some scenarios it may be desirable for the system to have the user confirm the template at 150 to ensure the user's physiological and/or behavioral characteristics match the template. In the event of a mismatch at this stage, the user may be prompted for recapture of one or more physiological and/or behavioral characteristics.

Verifying documents are stored by the user at 160 on the storage component of the USB credit card flash drive in reference to, in association with or in connection with the user profile or account such that access thereto is prevented without input matching the one or more physiological or behavioral characteristic templates registered with the user profile or account. Verifying documents stored may include one or more of medical records, certifications, asset ownership proof, licenses, insurances, passports, visas or a combination of these.

Storing of verifying documents may include or require physically connecting the USB credit card flash drive to a verifying documents source by universal serial bus. In an example, a USB connector may be manipulated to enable or simplify connecting the USB credit card flash drive to a verifying documents source such as by pivoting or sliding the USB connector.

In some examples, the storing of verifying documents may be denied when authorization is required to store documents and it is determined that one or more physiological or behavioral characteristics captured by the USB credit card flash drive mismatch with the one or more physiological or behavioral characteristic keys.

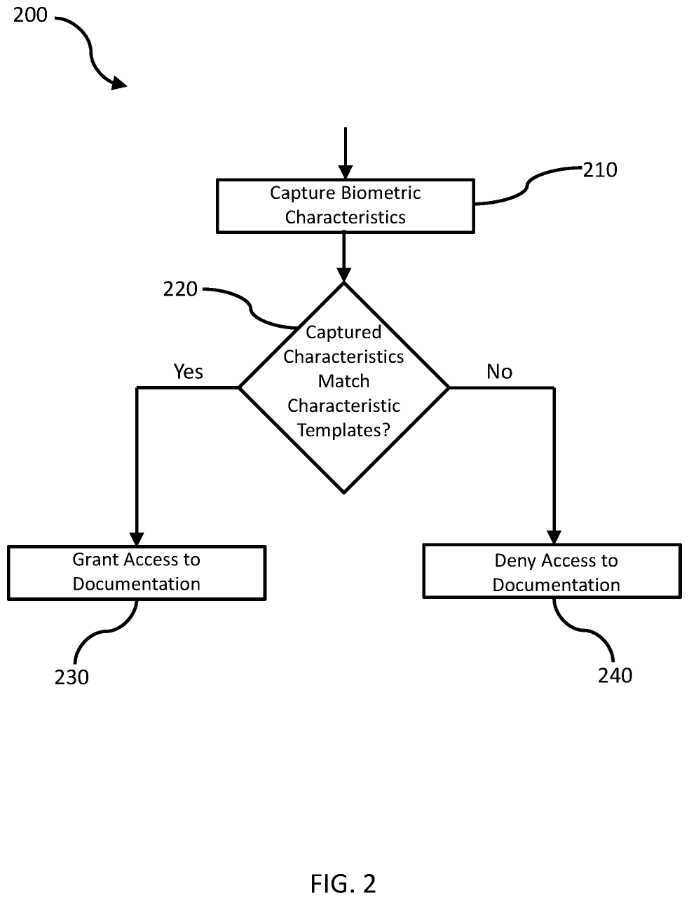

FIG. 2 illustrates a flow of an example method 200 for secure storage and transport of documents. The method includes capturing one or more physiological or behavioral characteristics with a biometric or behaviometric scanner provided to a USB credit card flash drive. The one or more physiological or behavioral characteristics may be captured with a camera, an IR sensor, a chemical sensor, an input of a USB credit card flash drive, a touchpad, or a combination of these. One or more of fingerprints, palm vein images, DNA, palm print, hand geometry, ear shape, facial images, iris images, odor/scent and voices may be captured. Physiological, anatomical or behavioral characteristics may also include behaviometrics such as mouse movement, typing rhythm, gait, signature.

At 220, the captured one or more physiological or behavioral characteristics are compared with one or more physiological or behavioral characteristic templates previously stored as part of a user account to the USB credit card flash drive, for example, during account or profile enrollment. In this way it may be determined whether the user inputting the captured one or more physiological or behavioral characteristics is the user of the profile or account and is authorized to access the stored verifying documents. Based upon the results of the comparing at 220, access is controlled to verifying documents previously stored to the USB credit card flash drive or a memory or storage component thereof and accessible through the user account.

At 230, access to the verifying documents may be granted when the comparing produces a match and denied, prohibited or otherwise prevented at 240 when the comparing at 220 produces a mismatch. The comparing may further include computing a distance between elements of the one or more physiological or behavioral characteristic templates and elements of the one or more captured physiological or behavioral characteristics. The comparing may further include comparing the distance to a threshold. Granting access to the stored verifying documents may further include granting access when the computed distance is less than the threshold.

In an example, the USB credit card flash drive may be powered on in response to the granting of access to the stored verifying documents at 230. In other examples, the USB credit card flash drive is powered on independently from the access control process.

In another example, the access grant may be communicated by outputting a signal to the user by illuminating one or more lights, playing one or more sounds or displaying a graphical user interface either locally or on another piece of hardware physically coupled with the USB credit card flash drive. The one or more lights The may be illuminated according to a spatial or temporal pattern. The one or more icons representing the verifying documents stored to the storage component may be displayed with the graphical user interface.

Access may be denied or a signal may be provided that the user has been denied access to the stored verifying documents by powering down or not powering on the USB credit card flash drive, outputting a signal to the user by illuminating one or more lights, playing one or more sounds or not displaying a graphical user interface. Again, the one or more lights may be illuminated according to a spatial or temporal pattern.

The method may further include physically isolating the verifying documents from digital communications networks, for example, by restricting communicative coupling with the USB credit card flash drive to physical coupling only.

The actions described above are only illustrative and other alternatives can also be provided where one or more steps are added, one or more steps are removed, or one or more steps are provided in a different sequence without departing from the scope of the claims herein.

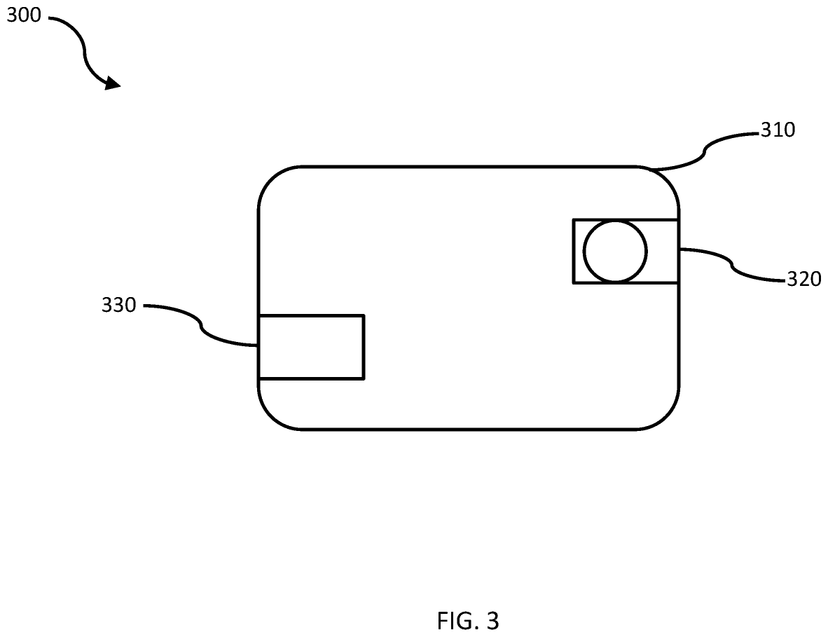

Methods disclosed above may be suitable for implementation on any of a variety of systems and devices to provide services associated with the secure storage and transport of documents. FIG. 3 schematically illustrates an example system 300 for secure storage and transport of documents. System 300 is optionally implemented by a mobile electronic device taking the general form of a wafer about the size of a commonly held credit card. This USB credit card flash drive has a shell housing a memory component, a storage component a biometric scanner 320, a processor and an input/output all mutually operatively coupled. The system may measure about 3.38″ by about 2.12″ by about 0.07″. Note that use of the phrase “USB credit card flash drive” is not intended to suggest the drive is a credit card or is used as such.

The USB credit card flash drive may include materials and/or one or more design features so as to be IP68 rated to be waterproof, dustproof, temperature resistant and may be resistant to X-rays, electromagnetic pulses and electrostatic discharge.

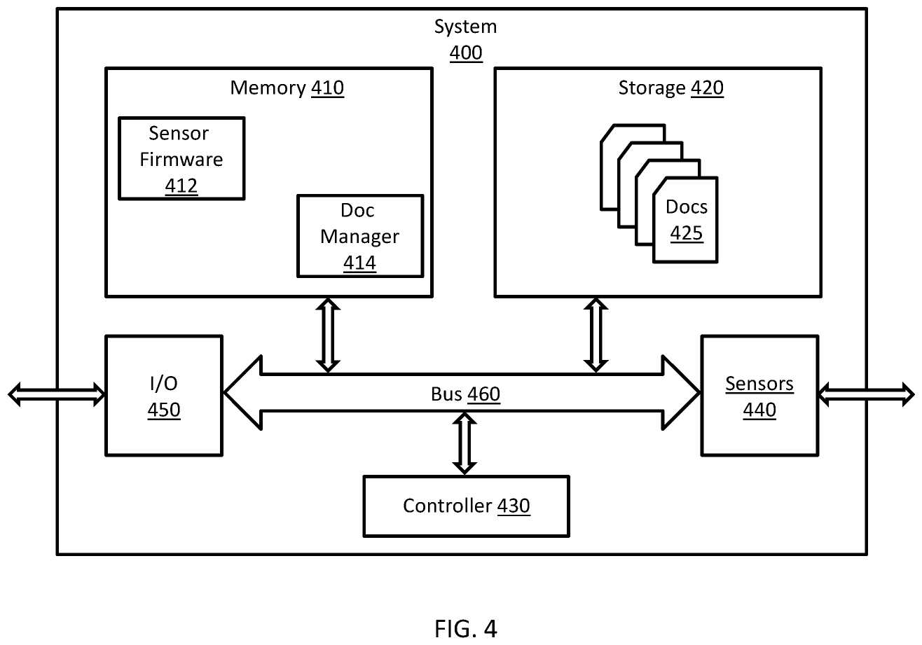

FIG. 4 schematically illustrates various components of a system 400 for secure storage and transport of documents, in accordance with an embodiment of the present disclosure. System 400 could be implemented as system 300 of FIG. 3 or vice versa.

System 400 includes, but is not limited to, a memory 410, a computing hardware such as a processor or controller 430, Input/Output (I/O) devices 450, sensors 440, a storage 420, and a system bus 460 that operatively couples various components including memory 410, processor or controller 430, I/O devices 450, sensors 440 and storage 420. I/O devices 450 include a port or other hardware interface 330 such as universal serial bus. In an example the universal serial bus uses USB 3.0 technology.

System 400 may include a power source for supplying electrical power to the various components of the system. Such a power source may for example, include a rechargeable battery. In another example, the system is powered by another device through a port or hardware interface.

Memory 410 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

Memory 410 stores sensor firmware 412 and a document manager 414. Sensor firmware 412 and a document manager 414 may for example, be parts of a software product associated with the secure storage and transport of documents service provided by the system. Executing the software product on processor or controller 430 may result in generating and rendering a graphical user interface configured to facilitate user interactions with the secure storage and transport of documents service. The graphical user interface may be rendered locally or on a display screen with which the system may be connected through I/O 450.

Further, sensors 440 may include one or more biometric scanners configured to scan one or more of fingerprints, palm vein images, DNA, palm print, hand geometry, ear shape, facial images, iris images, odor/scent and voices may be captured. Physiological, anatomical or behavioral characteristics may also include behaviometrics such as mouse movement, typing rhythm, gait, signature.

Sensors 440 may additionally be used to measure and collect data related to surroundings of the user. Additionally, outputs generated by sensors 440 may for example, be indicative of a match or mismatch between physiological or behavioral characteristics provided by a user and physiological or behavioral characteristic templates. In some examples, sensors 440 may include a GPS sensor for determining one or more absolute spatial positions of the user upon a surface of the Earth.

In some examples, sensors 440 may include a timer for including the time-stamps with the characteristics. Alternatively, processor or controller 430 may provide system time as reference for including the time-stamps with the physiological and/or behavioral characteristics.

In conjunction with sensors 440, I/O 450 may scan behaviometrics such as mouse movement, typing rhythm, gait, signature.

Moreover, storage 420 is a non-transient data storage medium. The software products, when executed on processor or controller 430, are optionally coupled to storage 420, and are configured to store verifying documents 425, update verifying documents 425 as well as grant and deny access to verifying documents 425 stored in storage 420. Processor or controller 430 may store verifying documents including medical records, certificates, certifications, grants, asset ownership proof, licenses, insurances, permissions, permits, identity documents, passports, travel documents and visas. Processor or controller 430 may also store user biometrics to storage 420, in particular, during the enrollment stage.

Memory 410 and storage 420, each alone or in combination, may have a memory capacity of between about 1 MB and about 1 TB or other amount suitable for the purposes of storing verification documents or verifying documents as generally disclosed herein.

As a cold wallet providing a network air gap, system 400 excludes a network interface. In an example, system 400 excludes transmitters, receivers, and does not connect to other devices through WiFi, Bluetooth or near field communication so that verifying documents 425 may be secure in cold storage.

When executed on processor or controller 430, the software causes processor or controller 430 to initialize an account with one or more physiological or behavioral characteristic templates provided through input/output 450 and/or a biometric scanner of sensors 440.

Processor or controller 430 creates a user profile on storage component 420. With one or more biometric scanners 330 and/or sensors 440, processor or controller 430 captures one or more physiological, anatomical or behavioral characteristics of a user. Information/data representative of one or more physiological or behavioral characteristics may be collected and sampled by processor or controller 430 to create one or more physiological or behavioral characteristic templates.

Verifying documents 425 are stored by processor or controller 430 in association with the user profile or account, on storage component 420 such that access thereto is prevented without input matching the biometric data of the user of the profile or account.

Stored verifying documents 425 may further include one or more of medical records, certifications, asset ownership proof, licenses, insurance, passports and visas. File types stored may include text files, images files, video files or combinations of these.

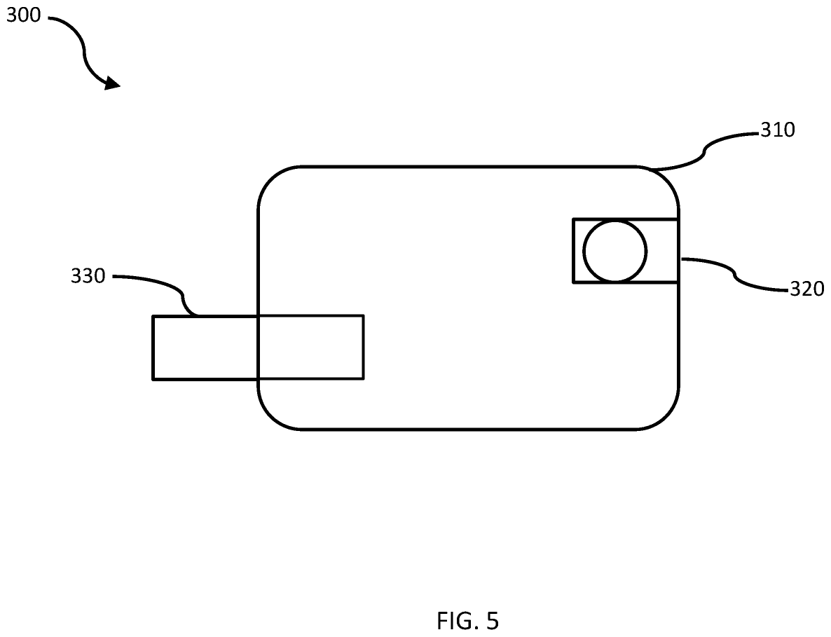

Verifying documents 425 may be stored by physically connecting system 300 and/or system 400 to a verifying documents source. Physical connection may be by universal serial bus. Verifying documents 425 may be stored to storage component 420 of system 400 and/or system 300 by manipulating an I/O device 450 implemented as a USB connector 330 (FIG. 5) and inserting I/O device 450 and/or USB connector into another device. In an example, USB connector 330 is manipulated by pivoting or sliding.

In some examples, processor or controller 430 may decline to store of verifying documents 425 may be denied when it is determined that one or more physiological or behavioral characteristics captured by the USB credit card flash drive mismatch with the one or more physiological or behavioral characteristic templates.

Processor or controller 430 may capture one or more physiological or behavioral characteristics with the biometric scanner by capturing with a camera, an IR sensor, a chemical sensor or another input of the USB credit card flash drive such as a touchpad. Processor or controller 430 may capture one or more of gestures, fingerprints, facial images, iris images and voices.

Processor or controller 430 compares the captured one or more physiological or behavioral characteristics with one or more physiological or behavioral characteristic templates previously stored as part of a user account to storage component 420. Based upon results of the comparison, control access to verifying documents 425 previously stored to the storage component and accessible through the user account.

Processor or controller 430 may grant access to verifying documents 425 when the comparing produces a match and deny, prohibit or otherwise prevent access to verifying documents 425 when the comparing produces a mismatch. Processor or controller 430 may compare by computing a distance between elements of the one or more physiological or behavioral characteristic templates and elements of the one or more captured physiological or behavioral characteristics. Processor or controller 430 may compare the distance to a threshold. Granting access to stored verifying documents 425 may further include granting access when the computed distance is less than the threshold.

Processor or controller 430 may grant access or otherwise signal the user has been granted access to stored verifying documents 425 by powering on the USB credit card flash drive. In other examples, the USB credit card flash drive has a power button independent from the access control process which connects components of the USB credit card flash drive to the power source.

Processor or controller 430 may additionally and/or alternatively grant access or otherwise signal the user has been granted access to stored verifying documents 425 by outputting a signal to the user. A signal could be illuminating one or more lights, playing one or more sounds or displaying a graphical user interface either locally or on another piece of hardware physically coupled with the USB credit card flash drive. Processor or controller 430 may illuminate the one or more lights according to a spatial or temporal pattern. With the graphical user interface, processor or controller 430 may display one or more icons representing verifying documents 425 stored to the storage component.

Processor or controller 430 may deny access or otherwise signal the user has been denied access to stored verifying documents 425 by powering down or not powering on the USB credit card flash drive, outputting a signal to the user by illuminating one or more lights, playing one or more sounds or not displaying a graphical user interface. Processor or controller 430 may illuminate the one or more lights according to a spatial or temporal pattern.

FIGS. 3-5 represent mere examples which should not unduly limit the scope of the claims herein. It is to be understood that the specific designation for the system is provided as an example and is not to be construed as limiting the system to specific numbers, types, or arrangements of modules and/or. A person skilled in the art will recognize many variations, alternatives, and modifications of embodiments of the present disclosure.

Embodiments of the present disclosure provide a computer program product that includes a non-transitory or non-transient computer-readable storage medium storing computer-executable code for storage, transport and protection of verifying documents. The code, when executed, is configured to perform the actions of the methods as described in conjunction with FIGS. 1 & 2. As actions of the disclosed methods may be provided in different sequences, so the computer-executable code may be configured to provide a service having a different sequence of actions from those illustrated in FIGS. 1 & 2. Further, the code may be implemented as the software referred to above and suitable for use by processor or controller 430.

In one example, a computer program product has program code embodied therewith executable by a processor to perform a method for secure storage and transport of documents. The method performed by the processor in accordance with the program code includes creating a user profile on a storage component of a USB credit card flash drive, with one or more components of the USB credit card flash drive, capturing one or more physiological, anatomical or behavioral characteristics of a user, on the storage component, storing, in association with the user profile, biometric data describing the physiological, anatomical or behavioral characteristics or parts thereof and storing verifying documents, in association with the user profile, on the storage component such that access thereto is prevented without input matching the biometric data.

In another example, the program code is executable by a processor to capture one or more physiological or behavioral characteristics with a biometric scanner provided to a USB credit card flash drive, compare the captured one or more physiological or behavioral characteristics with one or more physiological or behavioral characteristic templates previously stored as part of a user account to the USB credit card flash drive and, based upon results of the comparison, control access to verifying documents previously stored to the USB credit card flash drive and accessible through the user account.

Embodiments of the present disclosure are susceptible to being used for various purposes, including, though not limited to, enabling users to access verifying documents including critical personal information immediately in any situation including those in which they are misplaced from their homes, residences or workplaces on short notice.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A method for secure storage and transport of documents, comprising:
capturing one or more physiological or behavioral characteristics with a biometric scanner provided to a USB credit card flash drive;
comparing the captured one or more physiological or behavioral characteristics with one or more physiological or behavioral characteristic templates previously stored as part of a user account to the USB credit card flash drive; and
based upon results of the comparing, controlling access to verifying documents previously stored to the USB credit card flash drive and accessible through the user account.

2. The method as set forth in claim 1, wherein the capturing one or more physiological or behavioral characteristics further comprises capturing one or more of fingerprints, palm vein images, DNA, palm print, hand geometry, ear shape, facial images, iris images, odor/scent, voices gestures, mouse movement, typing rhythm, gait and signature.

3. The method as set forth in claim 1, wherein controlling access to the verifying documents further comprises:
granting access to the verifying documents when the comparing produces a match with one or more of the physiological or behavioral characteristic templates; and
denying access to the verifying documents when the comparing produces a mismatch with the physiological or behavioral characteristic templates.

4. The method as set forth in claim 3, wherein granting access to the stored verifying documents further comprises powering on the USB credit card flash drive.

5. The method as set forth in claim 3, wherein granting access to the stored verifying documents further comprises outputting a signal to the user.

6. The method as set forth in claim 1, wherein the comparing further comprises computing a distance between elements of the one or more physiological or behavioral characteristic templates and elements of the one or more captured physiological or behavioral characteristics.

7. The method as set forth in claim 1, further comprising physically isolating the verifying documents from digital communications networks by restricting communicative coupling with the USB credit card flash drive to physical coupling only.

8. A system for secure storage and transport of documents, comprising:
a USB credit card flash drive having a shell housing a storage component, a biometric scanner, a processor and an input/output all mutually operatively coupled;
wherein the processor is configured to:
capture one or more physiological or behavioral characteristics with the biometric scanner;
compare the captured one or more physiological or behavioral characteristics with one or more physiological or behavioral characteristic templates previously stored as part of a user account to the storage component; and
based upon results of the comparison, control access to verifying documents previously stored to the storage component and accessible through the user account.

9. The system as set forth in claim 8, wherein the processor is configured to capture the one or more physiological or behavioral characteristics by capturing one or more of one or more of fingerprints, palm vein images, DNA, palm print, hand geometry, ear shape, facial images, iris images, odor/scent, voices gestures, mouse movement, typing rhythm, gait and signature.

10. The system as set forth in claim 8, wherein the processor is configured to control access to the verifying documents by:
granting access to the verifying documents when the comparing produces a match with one or more of the physiological or behavioral characteristic templates; and
denying access to the verifying documents when the comparing produces a mismatch with the physiological or behavioral characteristic templates.

11. The system as set forth in claim 10, wherein the processor is configured to grant access to the stored verifying documents by powering on the USB credit card flash drive.

12. The system as set forth in claim 10, wherein the processor is configured to grant access to the stored verifying documents by outputting a signal to the user.

13. The system as set forth in claim 8, wherein the processor is configured to compare by computing a distance between elements of the one or more physiological or behavioral characteristic templates and elements of the one or more captured physiological or behavioral characteristics.

14. The system as set forth in claim 8, wherein the storage component is isolated from digital communications networks by restricting communicative coupling with the USB credit card flash drive to physical coupling only.

15. A computer program product comprising a non-transitory computer readable storage medium having program code embodied therewith, the program code being executable by a processor to:
capture one or more physiological or behavioral characteristics with a biometric scanner provided to a USB credit card flash drive;
compare the captured one or more physiological or behavioral characteristics with one or more physiological or behavioral characteristic templates previously stored as part of a user account to the USB credit card flash drive; and
based upon results of the comparison, control access to verifying documents previously stored to the USB credit card flash drive and accessible through the user account.

16. The computer program product as set forth in claim 15, wherein the program code executable by the processor to capture one or more physiological or behavioral characteristics is further executable by the processor to capture one or more of one or more of fingerprints, palm vein images, DNA, palm print, hand geometry, ear shape, facial images, iris images, odor/scent, voices gestures, mouse movement, typing rhythm, gait and signature.

17. The computer program product as set forth in claim 15, wherein the program code executable by the processor to control access to the verifying documents is further executable by the processor to:
grant access to the verifying documents when the comparing produces a match with one or more of the physiological or behavioral characteristic templates; and
deny access to the verifying documents when the comparing produces a mismatch with the physiological or behavioral characteristic templates.

18. The computer program product as set forth in claim 17, wherein the program code executable by the processor to grant access to the stored verifying documents is further executable by the processor to power on the USB credit card flash drive.

19. The computer program product as set forth in claim 17, wherein the program code executable by the processor to grant access to the stored verifying documents is further executable by the processor to output a signal to the user.

20. The computer program product as set forth in claim 15, wherein the program code executable by the processor to compare is further executable by the processor to compute a distance between elements of the one or more physiological or behavioral characteristic templates and elements of the one or more captured physiological or behavioral characteristics.

21. The computer program product as set forth in claim 15, wherein the program code is further executable by the processor to physically isolate the verifying documents from digital communications networks by restricting communicative coupling with the USB credit card flash drive to physical coupling only.
